(19) United States
(12) Patent Application Publication
(10) Pub. No.: US 2010/0308544 A1
(43) Pub. Date: Dec. 9, 2010

(54) Flexible Double-Valve

(76) Inventor: Ken Riis, Odense M (DK)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/599,642

(22) PCT Filed: Apr. 17, 2008
(86) PCT No.: PCT/DK2008/000143

§ 371 Date: Dec. 10, 2009

(30) Foreign Application Priority Data
May 10, 2007 (DK) PA 2007 00728

(51) Int. Cl. F16L 21/03

(52) U.S. Cl. 277/602

(57) ABSTRACT

The present invention relates to a sealing device (1) for mounting in a fluid passage (7) of a connection piece (5) such as beer extractor tube for a beer keg (13) characterised in that the sealing device (1) is adapted to be permanently-deformed when it is removed from said fluid passage (7).

### TECHNICAL FIELD OF THE INVENTION

The present invention relates to a sealing device for mounting in a fluid passage of a connection piece such as a beer extractor tube for a beer keg.

### BACKGROUND OF THE INVENTION

Sealing of fluid passages is widely used in fluid handling systems designed to store, transport, dispense or utilise fluids. Examples are beverage dispensing systems, hydraulic systems, refrigeration systems, heating systems, sanitary systems etc. In some examples, the fluid is in liquid form whereas in other examples, the fluid is in gaseous form, and yet in other examples the fluid changes form within the system. Some systems are designed to handle a single fluid type, whereas other systems are designed to handle different fluid types at the same time, and in some cases even different fluids in varying forms. Evidently, with the many applications and variations in fluid type and form, several requirements to the sealing devices for the fluid passages of the fluid handling systems exist. Fluid passages are the ducts, valves, pipe etc. comprised by the fluid systems.

An example of application of a sealing device is when the pipe elements of metal are connected in a joint, where a sealing device in the shape of a rubber O-ring is compressed between the two pipe elements whereby a sealed connection is achieved. In general, it is common for sealing devices to comprise a flexible element on which a force is exerted when the sealing device is inserted in the fluid passage, whereby a sealing connection is achieved.

In some applications, a sealing device is used to fill and seal the space between two objects, generally to prevent leakage between the two objects. Such sealing devices are also known as gaskets. A challenge in this type of application is to mount and dismount the sealing device between the two objects without having to dismantle either of the two objects.

Sealing devices are in some applications required to be able to seal against more than one fluid flow. For instance, in the example of gaskets, the sealing device typically needs to form a sealing connection with both of the two objects to prevent leakage between them.

In certain applications, sealing devices are required to be capable of switching between an on-state in which it allows fluid to pass and an off-state in which it seals against fluid flow.

Especially in beverage handling systems, such as dispensing systems for e.g. beer, it is imperative to prevent contamination of the fluid by e.g. bacteria. Hence, the fluid passages and the sealing devices should be designed to minimise microbial growth as well as to be easy to clean. Sealing devices comprising flexible elements of for instance soft rubber are especially amenable for microbial growth, as the relatively rough surface finish provides suitable habitats for bacteria etc. Also, any grooves, dents and other apertures of the sealing devices are quite amenable for microbial growth. In some examples of the current art, microbial growth is sought minimised by providing sealing devices with as few apertures as possible. A drawback of this is that it constrains the functionality of the sealing device. Also, the microbial growth is slowed down, but not eliminated.

In other examples of prior art, the sealing devices are designed so that they are to be taken out prior to being cleaned, enabling a thorough cleaning. A drawback of this is that it is time consuming and cumbersome to dismantle the fluid handling system every time it needs to be cleaned.

Another way of overcoming the problems with microbial growth, is to instruct the user of the fluid handling system to replace the sealing devices and other critical parts of the system frequently, and thereby limit the amount of time bacteria etc. are allowed to grow. A drawback of this is that it then relies on the morale and competency of the user of the fluid handling system that the instructions to replace the sealing devices are respected. Laziness, effort to save cost, or simple ignorance may lead to the sealing devices not being replaced frequently enough to provide a satisfactory prevention of microbial growth.

Hence, there is a need for providing a sealing device with satisfactory sealing capabilities and a foolproof, easy and efficient prevention of microbial growth. Also, there is a need for the sealing device to be easy to mount and dismount. Further, there is a need for the sealing device to be able to form a sealing connection against more than one surface.

### SUMMARY OF THE INVENTION

An object of the present invention is to wholly or partly overcome the above disadvantages and drawbacks of the prior art. More specifically, it is an object to provide a sealing device for mounting in a fluid passage of a connection piece such as a beer extractor tube for a beer keg, with satisfactory sealing capabilities and a fool-proof, easy and efficient prevention of microbial growth. The present invention provides a sealing device that is adapted to be permanently deformed when it is removed from said fluid passage. By the sealing device being permanently deformed upon removal from the fluid passage, the user is prevented from re-using the sealing device, whereby the risk of contamination of the fluid is decreased significantly. The permanent deformation also visibly makes the user aware that the sealing device is not designed to be reused.

The sealing device may be adapted to be elastically deformed during insertion into said fluid passage. This makes it possible to insert the sealing device in fluid passages with dimensions smaller than those of the sealing device. Hence, it becomes possible to mount the sealing device without having to dismantle the fluid passage. Additionally, the elastic capability makes the sealing device compatible with varying dimensions of fluid passages. Also, the elastic deformation may serve to exert a force on the sealing device so that a better sealing capability is achieved as the sealing device is pressed against the fluid passage. Furthermore, the elastic deformation during insertion may assist the permanent deformation of the sealing device when taken out.

The sealing device may be pressed against the inner surface of the fluid passage by a first spring when said first spring is in a first compressed state. In this way, a sealing connection between the inner surface of the fluid passage and a first surface of the sealing device may be established. The sealing device may be released from contact with the inner surface of the fluid passage when said first spring is in a second compressed state. In this way, it is possible to change the sealing device from a first state, where it seals against fluid flow between the inner surface of the fluid passage and the sealing device, to a second state, where it allows fluid flow between the inner surface of the fluid passage and the sealing device.

The sealing device may comprise a duct. The duct may be engaged by a member, such as a valve. The member may be pressed against said duct by a second spring when said second spring is in a first compressed state. In this way, a sealing connection between a surface of the member and the duct comprised by the sealing device may be established. The member may be released from contact with said duct when said second spring is in a second compressed state. In this way, it is possible to change the sealing device from a first state, where it seals against fluid flow between a surface of the member and the duct comprised by the sealing device, to a second state, where it allows fluid flow between a surface of the member and the duct comprised by the sealing device.

The sealing device may be shaped as a torus by comprising a cross-section being revolved 360° about an axis coplanar with said cross-section. The sealing device may comprise a first surface facing radially towards said axis and a second surface facing radially outwards from said axis. By being torus-shaped and having the first surface and the second surface, the sealing device can seal a fluid passage via contact between its second surface and the fluid passage's inner surface, while at the same time housing the member such as a valve which is connected to its inner surface.

The second surface of the sealing device may comprise an extending portion extending radially outwards at an angle α from said axis P. The extending portion is advantageous, as it makes it possible to vary the dispersion of strain within the sealing device depending on the direction from which a force is exerted on it. By extending radially outwards, the extending portion enables the sealing device to be inserted into a fluid passage with an opening being smaller than the sealing device itself, as the extending portion can be flipped inwards as the sealing device is pressed into the fluid passage. If the interior of the fluid passage is larger than its opening, the extending portion will flip back to its original position once it has been pressed through the opening of the fluid passage. As it is extending radially outwards at an angle α from the axis P, the extending portion must be flipped further away from its original position to allow the sealing device to be removed from the fluid passage, provided that the angle α is acute. This enables the sealing device to be permanently deformed when removed from the fluid passage, whereas it is elastically deformed when inserted into the fluid passage. In this way, reuse of the sealing device is prevented, which decreases the risk of microbial growth.

The sealing device may comprise a sealing body comprising a bushing. This is advantageous, as it makes it easier for the sealing device to have a satisfactory sealing capability as well as the capability of permanent deformation after removal from the fluid passage. For instance, if the sealing body is made from a material with a higher elasticity than that of the material from which the bushing is made, the sealing device can be elastically deformed when strained in one direction whereas it is permanently deformed when strained in the opposite direction. Also, by the respective materials of the sealing body and the bushing having different elasticities and/or different yield strengths, the sealing body can provide the desired sealing capability, while the bushing provides the capability of permanent deformation upon removal from the fluid passage.

The sealing device may be so that said bushing is confined in said sealing body. This is advantageous as it prevents the bushing from being in contact with the fluid, whereby there are less constraints on the selection of material for the bushing.

The sealing device may be so that said bushing is torus-shaped and extends into said extending portion. This is advantageous, as it enables the bushing to work together with the extending portion, whereby the extending portion can provide a better sealing capability. Also, the bushing can help to provide a permanent deformation of the sealing device when the sealing device is removed form the fluid passage.

The sealing device may be so that said bushing comprises a plurality of radial cuttings. This is advantageous, as it increases the elasticity of the bushing without significantly decreasing the sealing capabilities of the sealing device.

### BRIEF DESCRIPTION OF THE DRAWINGS

The invention and its many advantages will be described in more detail below with reference to the accompanying schematic drawings, which for the purpose of illustration show some non-limiting embodiments and in which

FIG. 1 shows a cross section of a sealing device according to the invention being inserted in a fluid passage,

FIG. 2 shows a perspective view of an embodiment of a sealing device according to the invention,

FIG. 3 shows an insert for an embodiment of a sealing device according to the invention,

FIG. 4 shows a bushing for an embodiment of a sealing device according to the invention, and

FIG. 5 shows a top view of a sealing device according to the invention during insertion into a fluid passage,

FIG. 6 shows a top view of a sealing device according to the invention inserted in a fluid passage,

FIG. 7 shows a perspective view of a sealing device according to the invention during removal from a fluid passage,

FIG. 8 shows a side view of a sealing device according to the invention after it has been removed from a fluid passage, and

FIG. 9 shows a cross sectional view of an embodiment of a sealing device according to the invention being inserted in and removed from a fluid passage.

All the figures are highly schematic, not necessarily to scale, and they show only parts which are necessary in order to elucidate the invention, other parts being omitted or merely suggested.

### DETAILED DESCRIPTION OF PREFERRED EMBODIMENTS

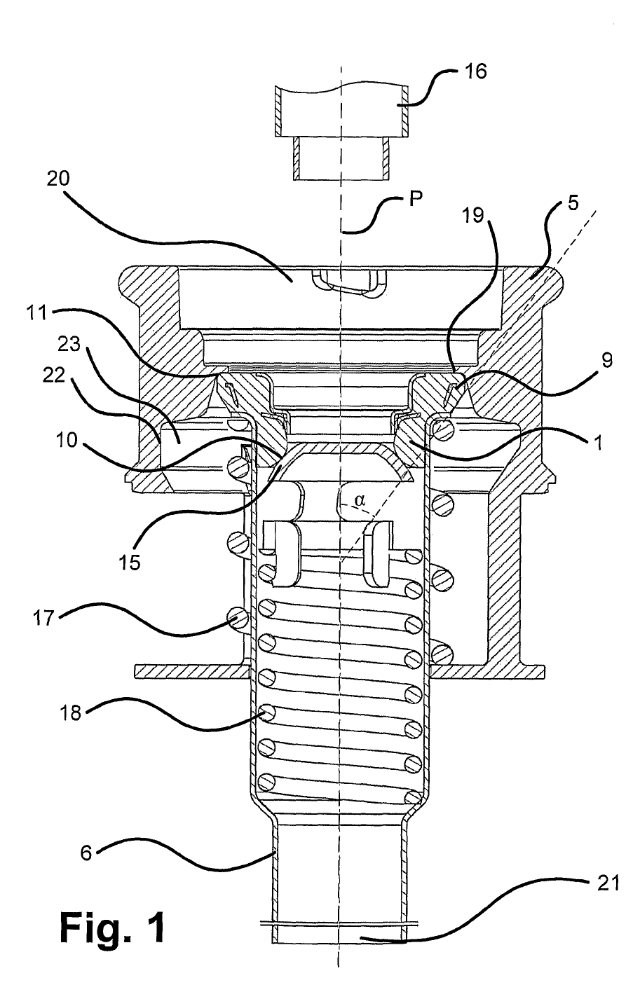

In FIG. 1 is shown a cross-sectional view of a preferred embodiment of a sealing device 1 according to the invention that is inserted in an example of a fluid passage 7 (not denoted in FIG. 1). The fluid passage 7 is comprised by a connection piece 5 for a beer keg 13 (not shown). The fluid passage 7 is encircled by the connection piece 5, and it extends from the top portion 20 of the connection piece 5 all the way to the bottom portion 21 of connection piece 5 along the centre axis P of the connection piece 5, thus allowing fluid flow through the connection piece 5. The circumference of the fluid passage tapers from the top portion 20 of the connection piece to an opening 19. From the opening 19 and towards the approximate mid-portion 22 of the connection piece 5, the fluid passage 7 widens, and from the approximate mid-portion 22 and towards the bottom portion 21 of the connection piece 5, the circumference of the fluid passage 7 tapers. It is a challenge to insert a sealing device 1 into the mid portion 22 of such a connection piece 5, since the top portion 20 as well as the bottom portion 21 comprises openings being narrower than the mid portion 22. In the prior art this was usually overcome by dismantling the connection piece 5 prior to insertion of the sealing device 1. In FIG. 1, a preferred embodiment of a sealing device 1 according to the invention has been inserted into the fluid passage 7 via the opening 19. The capability of the sealing device 1 to be elastically deformed makes this possible. In the preferred embodiment of the sealing device 1 shown in FIG. 1, the elastic capability is provided by an extending portion 9 which extends radially outwards from the axis P at an angle α. When the sealing device 1 is pressed through the opening 19 in a direction parallel to the axis P, the extending portion 9 flips inwards so that the sealing device can pass the opening 19. Once the sealing device has passed the opening 19, the extending portion flips back to its original position, and a sealing connection between the wall of the fluid passage 7 and the sealing device 1 is established. In other preferred embodiments, the elastic capability may be achieved by other designs of the sealing device, such as with more than one extending portion, by means of grooves or any other suitable design that enables a temporary elastic deformation during insertion into a fluid passage 7 of a connection piece 5. Furthermore, the sealing device 1 according to the invention can be used for other types of connection pieces than the example shown in FIG. 1, and the person skilled in the art will see that the sealing device according to the invention is suitable for insertion in fluid passages that taper and is comprised by other connection pieces than that shown in FIG. 1.

The connection piece 5 shown in FIG. 1 comprises a first spring 17, a second spring 18, a beer valve 15, a down tube 6, and a chamber 23. The down tube 6 extends into the beer keg 13 (not shown) and is connected to the beer valve 15. The second spring 18 is arranged to press the beer valve 15 against the sealing device 1 in such a manner that a sealing connection is formed across a first surface 10 of the sealing device 1. The sealing connection across the first surface 10 seals against fluid flow from the beer keg 13, via the down tube 6 and further into the top portion 20 of the connection piece 5. Also, the sealing connection across the first surface 10 seals against fluid flow from the top portion 20 of the connection piece 5, via the down tube 6 further into the beer keg 13. The first spring 17 is arranged to press the sealing device 1 against the wall of the fluid passage 7 in such a manner that a sealing connection is formed across a second surface 11. The sealing connection across the second surface 11 seals against fluid flow from the top portion 20, via the chamber 23 further into the beer keg 13. Also, the sealing connection across the second surface 11 seals against fluid flow from the beer keg 13, via the chamber 23 further into the top portion 20.

The connection piece 5 comprising the preferred embodiment of the sealing device 1 shown in FIG. 1, is adapted to be engaged by a dispensing device 16, of which the lower portion is shown in FIG. 1. When engaging the connection piece 5 in a downwards translation, the dispensing device 16 firstly engages the beer valve 15, compressing the second spring 18, and secondly it engages the sealing device 1, compressing the first spring 17. In this way, the second spring 18 is compressed more than the first spring 17, whereby the two sealing connections across the surfaces 10 and 11 are opened. This enables flow of carbon dioxide from the dispensing device 16, via the chamber 23, into the beer keg 13, and beer from the beer keg 13, via the down tube 6, and into the dispensing device 16.

The sealing device 1 should be possible to remove without having to replace the entire connection piece 5. For hygienic reasons, it should not be possible to re-insert a used sealing device 1 into the connection piece 5. According to the invention, the sealing device 1 is adapted to be permanently deformed when removed from the fluid passage 7 of the connection piece 5. In the preferred embodiment of the sealing device 1 shown in FIG. 1, the extending portion 9 of the sealing device extending radially outwards at an angle α to the axis P provides the disability of the sealing device to be removed from the fluid passage 7 without being permanently deformed. In the preferred embodiment, the angle α is acute, and in an even more preferred embodiment, the angle α is 20-45 degrees.

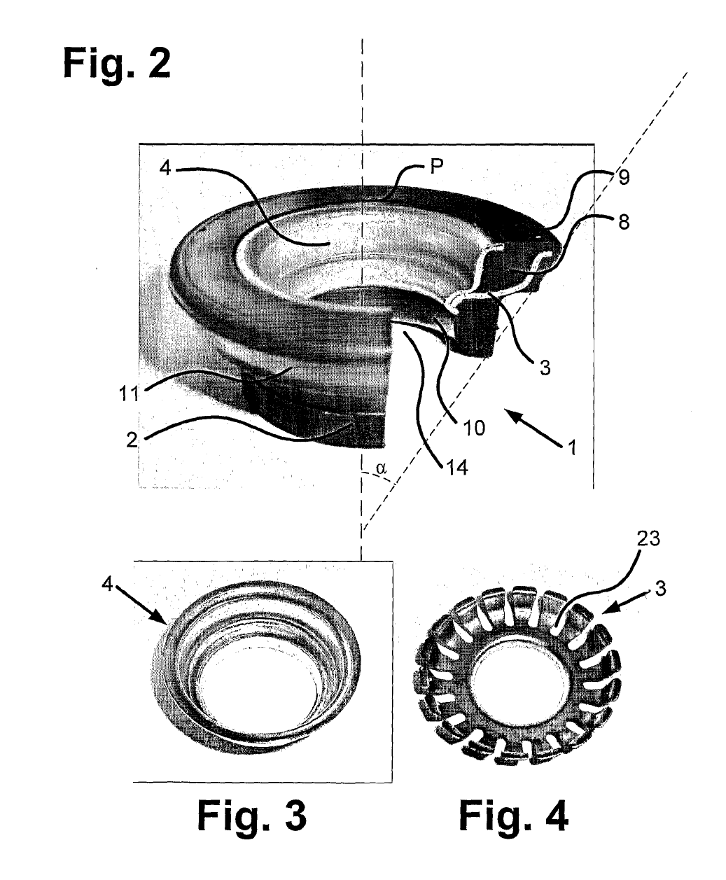

FIG. 2 shows a preferred embodiment of a sealing device 1 according to the invention. The sealing device 1 is shown in a perspective view with a quarter of it cut-out, providing the viewer with a cross-sectional view of the interior. The preferred embodiment of the sealing device 1 is torus shaped in that it comprises a cross-section 8 being revolved 360° about an axis (P) coplanar with the cross-section 8. Likewise, the sealing device 1 comprises a duct 14 that can engage other members, such as a valve or a dispensing device as shown in FIG. 1. The sealing device 1 comprises an insert 4, which is shown separately in FIG. 3, and a bushing 3, which is shown separately in FIG. 4. As shown in FIG. 3, the bushing 3 is torus-shaped and confined in the sealing body 2 of the preferred embodiment of the sealing device 1. Also, the bushing 3 extends into the extending portion 9 of the sealing device 1. Thereby, the bushing 3 can work together with the sealing body 2 and the extending portion 9 when the sealing device 1 is exposed to a force, for instance when being pressed into an opening 19 of a fluid passage 7 with a circumference smaller than the outer dimensions of the sealing device 1 (as in the example shown in FIG. 1). By extending radially outwards at an angle α to the axis P, the extending portion 9 can be elastically deformed when strained from a first direction (i.e. during insertion into a fluid passage 7 as that shown in FIG. 1), whereas it is permanently deformed when strained from a second direction (i.e. during removal from a fluid passage 7 as that shown in FIG. 1) being opposite to the first direction. In the preferred embodiment shown in FIG. 4, the bushing comprises a plurality of radial cuttings 23. These radial cuttings provide a larger degree of elasticity to the sealing device 1 while only slightly decreasing the compressive strength of the sealing device 1. The insert 4 is in the preferred embodiment shown in FIG. 2 connected to the bushing 3. The insert 4 is adapted to be engaged by tools for insertion and removal of the sealing device into and from a fluid passage 7.

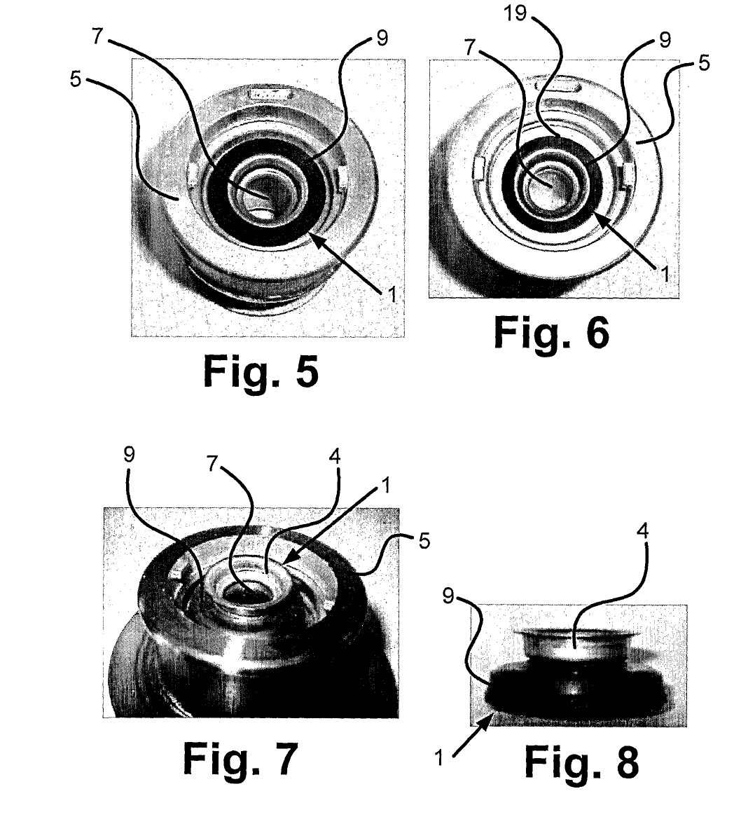

FIG. 5 and FIG. 6 show from above the sealing device 1 and the connection piece 5 comprising the fluid passage 7. In FIG. 5, the sealing device 1 is about to be inserted in the fluid passage 7 of the connection piece 5, and in FIG. 6 the sealing device 1 has been inserted in the fluid passage 7. As the opening 19 of the fluid passage 7 is smaller than the outer dimensions of the sealing device 1, the sealing device 1 is elastically deformed during the insertion of it into the fluid passage 7. In the preferred embodiment of the sealing device 1 shown in FIGS. 5 and 6, the sealing device comprises an extending portion 9, which provides the flexibility necessary for the deformation to be elastic. In the example of the connection piece 5 in FIGS. 5 and 6, the inner circumference of the fluid passage 7 is larger than that of the opening 19 of the fluid passage 7. The extending portion 9 enables a temporary adjustment of the circumference of the sealing device 1 during the insertion through the opening 19 of the fluid passage 7 during which it is flipped inwards, and upon passage through the opening 19 it returns to its initial shape as the inner dimensions of the fluid passage 7 are larger than those of the opening 19, whereby a sound sealing of the fluid passage 7 is achieved.

In FIG. 7 is shown a preferred embodiment of a sealing device 1 according to the invention during removal from an example of a fluid passage 7 of a connection piece 5. The example of the fluid passage 7 shown is a connection piece 5 for a beer keg 13, the same as in FIG. 1 and FIGS. 5-6. FIG. 7 shows the sealing device 1 and the fluid passage 7 in a perspective from above. In FIG. 7, the sealing device 1 is being removed from the fluid passage 7, and in FIG. 8 the sealing device 1 has been removed from the fluid passage 7, whereby the sealing device 1 has been permanently deformed. In the preferred embodiment of the sealing device shown in FIGS. 7 and 8, the permanent deformation is enabled by an extending portion 9 of the sealing device 1. The extending portion 9 extends from the torus-shaped sealing body of the sealing device 1 in an angle α relative to the plane of the sealing body (as shown in FIG. 1), whereby it can be deformed elastically when strained in a first direction, whereas it is permanently deformed when strained in a second direction opposite to the mentioned first direction. The ability of the sealing device to be elastically deformed respectively permanently deformed when strained in opposite directions can be achieved in other ways in other preferred embodiments, for instance by a different design of the extending portion 9 or by incorporating other angled components in the sealing device 1.

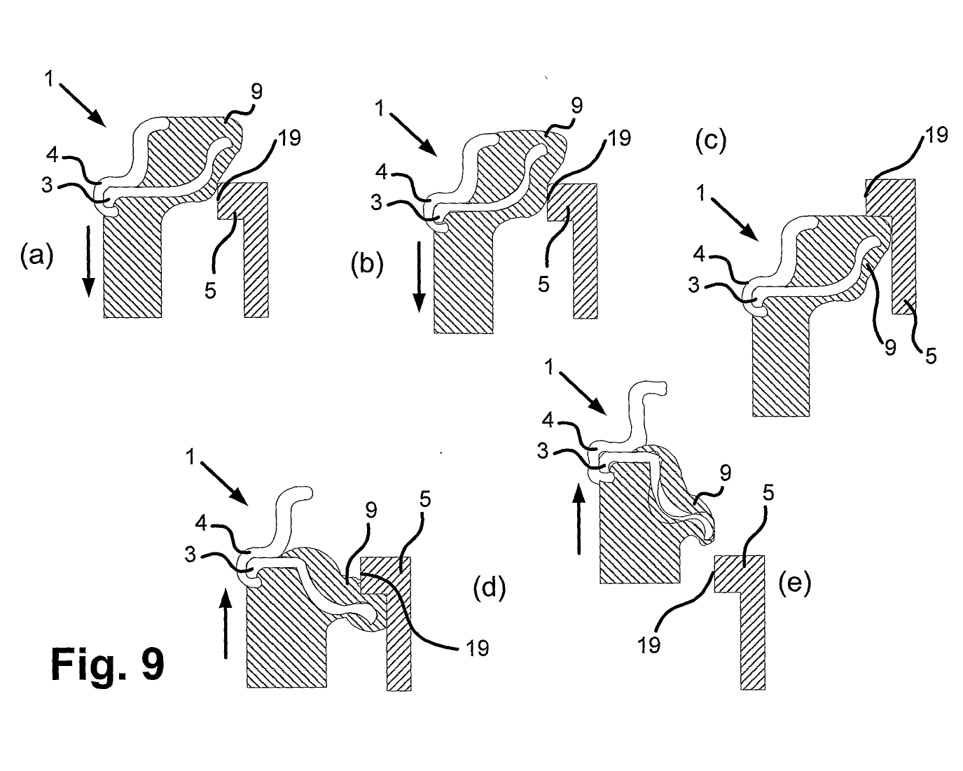

In FIG. 9, the elastic deformation of the sealing device 1 during insertion into a fluid passage 7 of a connection piece 5 is illustrated. FIG. 9 also illustrates the permanent deformation of the sealing device 1 during removal from a fluid passage 7 of a connection piece 5. In FIG. 9a, the sealing device 1 is just about to be pressed through the narrow opening 19 of the connection piece 5, and FIG. 9b shows the sealing device during its passage through the opening 19. As illustrated in FIG. 9b, the extending portion 9 comprising the bushing 3 must only be flipped slightly inwards to allow passage through the opening 19, and once the sealing device has passed the opening 19, the extending portion 9 flips back to its original position, as shown in FIG. 9c. In FIG. 9d, the sealing device is shown during removal from the connection piece, and as illustrated, the extending portion 9 comprising the bushing 3 must forced so much out of position to allow the sealing device to pass through the opening 19, that the sealing device is permanently deformed, as shown in FIG. 9e.

In a preferred embodiment, the sealing body 2 of the sealing device is made of a flexible material such as rubber and the bushing 3 and the insert 4 is made of a rigid material such as stainless steel or aluminium. It is, however, clear to the person skilled in the art, that other materials can be used without departing from the invention.

Although the invention above has been described in connection with preferred embodiments of the invention, it will be evident for a person skilled in the art that several modifications are conceivable without departing from the invention as defined by the following claims.

1. A sealing device for mounting in a fluid passage of a connection piece such as a beer extractor tube for a beer keg wherein the sealing device is adapted to be permanently deformed when it is removed from said fluid passage.

2. The sealing device according claim 1, wherein the sealing device is adapted to be elastically deformed during insertion into said fluid passage.

3. The sealing device according to claim 1, wherein said sealing device is pressed against the inner surface of the fluid passage by a first spring when said first spring is in a first compressed state.

4. The sealing device according to claim 3, wherein said sealing device is released from contact with the inner surface of the fluid passage when said first spring is in a second compressed state.

5. The sealing device according to claim 1, wherein the sealing device comprises a duct.

6. The sealing device according to claim 5, wherein said duct can be engaged by a member, such as a valve.

7. The sealing device according to claim 6, wherein said member is pressed against said duct by a second spring when said second spring is in a first compressed state.

8. The sealing device according to claim 7, wherein said member is released from contact with said duct when said second spring is in a second compressed state.

9. The sealing device according to claim 1, said sealing device being shaped as a torus by comprising a cross-section being revolved 360° about an axis (P) coplanar with said cross-section.

10. The sealing device according to claim 9 comprising a first surface facing radially towards said axis (P) and a second surface facing radially outwards from said axis (P).

11. The sealing device according to claim 10, wherein said second surface comprises an extending portion, said extending portion extending radially outwards at an angle (a) from said axis (P).

12. The sealing device according to claim 1, wherein said sealing device comprises a sealing body and a bushing.

13. The sealing device according to claim 12 wherein said bushing is confined in said sealing body.

14. The sealing device according to claim 12, wherein said bushing is torus-shaped and extends into said extending portion.

15. The sealing device according to claim 12, wherein said bushing comprises a plurality of radial cuttings.
